(19) United States
(12) Patent Application Publication
(10) Pub. No.: US 2014/0030606 A1
(43) Pub. Date: Jan. 30, 2014

(54) SEPARATOR FOR ELECTROCHEMICAL DEVICE, METHOD FOR PRODUCING THE SAME, AND ELECTROCHEMICAL DEVICE

(71) Applicants: Eri Kojima, Ibaraki-shi (JP); Takahiro Furutani, Ibaraki-shi (JP); Toshiyuki Watanabe, Ibaraki-shi (JP); Kunihiko Koyama, Ibaraki-shi (JP)

(72) Inventors: Eri Kojima, Ibaraki-shi (JP); Takahiro Furutani, Ibaraki-shi (JP); Toshiyuki Watanabe, Ibaraki-shi (JP); Kunihiko Koyama, Ibaraki-shi (JP)

(73) Assignee: HITACHI, LTD., Tokyo (JP)

(21) Appl. No.: 13/810,421

(22) PCT Filed: Mar. 12, 2012
(86) PCT No.: PCT/JP2012/056233

§ 371 Date: Jan. 15, 2013

(51) Int. Cl. H01M 2/16; H01M 2/14

(52) U.S. Cl. CPC H01M 2/1626; H01M 2/145
USPC 429/246; 429/249; 427/487

(57) ABSTRACT

The method for producing a separator for an electrochemical device of the present invention includes: obtaining a separator forming composition, wherein the separator forming composition contains a resin raw material including a monomer or an oligomer, a solvent (a) capable of dissolving the resin raw material; and a solvent (b) capable of causing the resin raw material to agglomerate by solvent shock, and V_{sb}/Vₛₐ as a ratio between the volume Vₛₐ of the solvent (a) and the volume V_{sb} of the solvent (b) is 0.04 to 0.2; applying the composition to a substrate; irradiating with energy rays a coating of the applied composition to form a resin (A) having a crosslinked structure; and drying the coating after the formation of the resin (A) to form pores. The separator for an electrochemical device of the present invention is produced by the production method of the present invention.

### TECHNICAL FIELD

The present invention relates to an electrochemical device having a high level of safety and reliability, a separator with which the electrochemical device can be formed, and a method for producing the separator.

### BACKGROUND ART

Electrochemical devices using a nonaqueous electrolyte, typified by supercapacitors and nonaqueous electrolyte secondary batteries such as a lithium secondary battery are characterized by their high energy density, and therefore are widely used as power sources for portable devices such as mobile phones and notebook personal computers. There is a trend toward a further increase in the capacity of electrochemical devices as portable devices have become more sophisticated, and it has become an important challenge to ensure higher safety of electrochemical devices.

In currently available lithium secondary batteries, a polyolefin-based porous film having a thickness of, for example, about 20 to 30 μm is used as a separator for being interposed between positive and negative electrodes. However, when producing such a polyolefin-based porous film, a complicated process such as biaxial drawing or extraction of a pore-forming agent is used under present circumstances to form fine and uniform pores in the film, which results in an increased cost and thus makes the separator expensive.

As the raw material of the separator, polyethylene having a melting point of about 120 to 140° C. is used in order to ensure a so-called shutdown effect by which the resin constituting the separator is melted at a temperature lower than or equal to the thermal runaway temperature of a battery to close the pores, thereby increasing the internal resistance of the battery and improving the level of safety of the battery at the time of short-circuiting or the like. However, if the temperature of the battery further increases after the shutdown, for example, the melted polyethylene becomes likely to flow, which may result in a so-called meltdown that causes damage to the separator. In such a case, the positive and negative electrodes come into direct contact with each other, causing a further increase in the temperature. And in a worst-case scenario, the battery may catch fire.

In order to prevent short-circuiting resulting from such a meltdown, it has been considered to use microporous films and nonwoven fabrics using heat-resistant resins as separators. However, there are problems associated with these separators such as requiring expensive materials and they being difficult to be produced.

In view of such circumstances, Patent Document 1, for example, proposes a technique of forming, on an electrode surface, a material that contains a crosslinked resin and functions as a separator by applying a paint containing an oligomer, a monomer, and the like on the electrode surface and irradiating the applied paint with energy rays. According to the technique described in Patent Document 1, a nonaqueous electrolyte secondary battery having a high level of safety at elevated temperatures can be produced at low cost.

### PRIOR ART DOCUMENT

### Patent Document

Patent Document 1: JP 2010-170770 A

### DISCLOSURE OF INVENTION

### Problem to be Solved by the Invention

In addition to being safe at elevated temperatures, electrochemical devices are required to be highly reliable, for example, do not have, when being charged/discharged, internal short-circuiting (micro short circuiting) that is ascribable to the development of lithium dendrites.

Although the technique described in Patent Document 1 can ensure the reliability of an electrochemical device to some extent, such an electrochemical device has room for improvement in reliability in comparison with, for example, a battery using a conventional polyolefin-based porous film separator.

With the foregoing in mind, it is an object of the present invention to provide an electrochemical device having a high level of safety and reliability, a separator with which the electrochemical device can be formed, and a method for producing the separator.

### Means for Solving Problem

In order to achieve the above object, the method for producing a separator for an electrochemical device of the present invention includes: preparing a separator forming composition, wherein the separator forming composition contains a resin raw material including at least one of a monomer and an oligomer that are polymerizable by energy ray irradiation, a solvent (a) capable of dissolving the resin raw material, and a solvent (b) capable of causing the resin raw material to agglomerate by solvent shock, and V_{sb}/Vₛₐ as the ratio between the volume Vₛₐ of the solvent (a) and the volume V_{sb} of the solvent (b) is 0.04 to 0.2; applying the separator forming composition to a substrate; irradiating with energy rays a coating of the separator forming composition applied to the substrate to form a resin (A) having a crosslinked structure; and drying the energy ray-irradiated coating of the separator forming composition to form pores.

Further, the separator for an electrochemical device of the present invention is produced by the method for producing a separator for an electrochemical device of the present invention.

Furthermore, the electrochemical device of the present invention includes a positive electrode, a negative electrode, a separator and a nonaqueous electrolyte, and the separator is the separator for an electrochemical device of the present invention.

### Effects of the Invention

According to the present invention, it is possible to provide an electrochemical device having a high level of safety and reliability, a separator with which the electrochemical device can be formed, and a method for producing the separator.

### BRIEF DESCRIPTION OF DRAWINGS

FIG. 1 includes schematic views of one example of the electrochemical device (nonaqueous electrolyte secondary battery) of the present invention: (a) is a plan view and (b) is a partial longitudinal sectional view of the exemplary electrochemical device.

FIG. 2 is a perspective view of the electrochemical device shown in FIG. 1.

### DESCRIPTION OF THE INVENTION

The separator for an electrochemical device of the present invention (hereinafter may be simply referred to as the “separator”) is produced by the method of the present invention, which includes the following steps: (1) the step of preparing a separator forming composition that contains a resin raw material including at least one of a monomer and an oligomer that are polymerizable by energy ray irradiation and solvents; (2) the step of applying the separator forming composition to a substrate; (3) the step of irradiating with energy rays a coating of the separator forming composition applied to the substrate to form a resin (A) having a crosslinked structure [hereinafter may be simply referred to as the “resin (A)”]; and (4) the step of drying the energy ray-irradiated coating of the separator forming composition to form pores. As the resin constituting the separator, the separator contains the resin (A) formed in the step (3).

The resin (A) of the separator of the present invention is at least partially crosslinked. Thus, even if the internal temperature of an electrochemical device that includes the separator of the present invention (i.e., the electrochemical device of the present invention) is elevated, the shrinkage and deformation of the separator ascribable to melting of the resin (A) are less likely to occur and the separator can thus maintain its shape favorably, thereby preventing shorting of the positive electrode and the negative electrode from occurring. For these reasons, the electrochemical device of the present invention including the separator of the present invention can be highly safe at elevated temperatures.

Further, in the method of the present invention for producing the separator of the present invention, specific solvents are used in the preparation of the separator forming composition, and this enables to form uniform pores, improving the lithium ion permeability of the separator of the present invention. Therefore, lithium dendrites are less likely to be produced in the electrochemical device using this separator, so that at the time of charging/discharging the electrochemical device micro-short circuiting that is ascribable to lithium dendrites can be favorably prevented from occurring. Thus, the electrochemical device of the present invention including the separator of the present invention has favorable charge/discharge characteristics and can be highly reliable.

The step (1) of the method of the present invention is a step in which the separator forming composition that contains a resin raw material including at least one of a monomer and an oligomer that are polymerizable by energy ray irradiation and solvents is prepared.

The resin raw material, such as a monomer or an oligomer that is polymerizable by energy ray irradiation, is polymerized in the step (3) to form the resin (A) having a crosslinked structure.

Specific examples of the resin (A) include: an acrylic resin formed from an acrylic resin monomer [alkyl(meth)acrylates such as methyl methacrylate and methyl acrylate and derivatives thereof], an oligomer thereof, and a crosslinking agent; a crosslinked resin formed from urethane acrylate and a crosslinking agent; a crosslinked resin formed from epoxy acrylate and a crosslinking agent; and a crosslinked resin formed from polyester acrylate and a crosslinking agent. As the crosslinking agent for any of the resins mentioned above, a bivalent or multivalent acrylic monomer such as dioxane glycol diacrylate, tricyclodecane dimethanol diacrylate, ethylene oxide modified trimethylolpropane triacrylate, dipentaerythritol pentaacrylate, caprolactone modified dipentaerythritol hexaacrylate, or ε-caprolactone modified dipentaerythritol hexaacrylate can be used.

Thus, when the resin (A) formed in the step (3) is the above-mentioned acrylic resin, the above examples of acrylic resin monomer and crosslinking agent can be used as the monomer that is polymerizable by energy ray irradiation (hereinafter, simply referred to as the “monomer”) and used in the separator forming composition prepared in the step (1). Further, an oligomer of the above examples of the acrylic resin monomer can be used as the oligomer that is polymerizable by energy ray irradiation (hereinafter, simply referred to as the “oligomer”) and used in the separator forming composition used in the step (1).

Furthermore, when the resin (A) formed in the step (3) is the crosslinked resin formed from urethane acrylate and a crosslinking agent, the above examples of crosslinking agent and the like can be used as the monomer used in the separator forming composition prepared in the step (1), and urethane acrylate can be used as the oligomer used in the separator forming composition prepared in the step (1).

On the other hand, when the resin (A) formed in the step (3) is the crosslinked resin formed from epoxy acrylate and a crosslinking agent, the above examples of crosslinking agent and the like can be used as the monomer used in the separator forming composition prepared in the step (1), and epoxy acrylate can be used as the oligomer used in the separator forming composition prepared in the step (1).

Furthermore, when the resin (A) formed in the step (3) is the crosslinked resin formed from polyester acrylate and a crosslinking agent, the above examples of crosslinking agent and the like can be used as the monomer used in the separator forming composition prepared in the step (1), and polyester acrylate can be used as the oligomer used in the separator forming composition prepared in the step (1).

Further, a crosslinked resin derived from an unsaturated polyester resin that is formed from a mixture of a styrene monomer and an ester composition produced by condensation polymerization between a bivalent or multivalent alcohol and dicarboxylic acid; a resin formed from polyfunctional epoxy, polyfunctional oxetane, or a mixture thereof, and various polyurethane resins produced by reaction between polyisocyanate and polyol can also be used as the resin (A).

Accordingly, when the resin (A) formed in the step (3) is the crosslinked resin derived from an unsaturated polyester resin, a styrene monomer can be used as the monomer used in the separator forming composition prepared in the step (1), and the above-described ester composition can be used as the oligomer used in the separator forming composition prepared in the step (1).

When the resin (A) is the resin formed from polyfunctional epoxy, polyfunctional oxetane, or a mixture thereof, examples of the polyfunctional epoxy include ethylene glycol diglycidyl ether, 1,6-hexanediol diglycidyl ether, neopentylglycol diglycidyl ether, glycerol polyglycidyl ether, sorbitol glycidyl ether, 3,4-epoxycyclohexenylmethyl-3′,4′-epoxycyclohexenecarboxylate, and 1,2:8,9 diepoxylimonene. Examples of the above polyfunctional oxetane include 3-ethyl-3{[(3-ethyloxetane-3-yl)methoxy]methyl}oxetane, and xylene bisoxetane.

Accordingly, when the resin (A) formed in the step (3) is the resin formed from polyfunctional epoxy, polyfunctional oxetane, or a mixture thereof, the above examples of polyfunctional epoxy and polyfunctional oxetane can be used as the monomer used in the separator forming composition prepared in the step (1).

When the resin (A) is one of the various polyurethane resins that are produced by reaction between polyisocyanate and polyol, examples of polyisocyanate include hexamethylene diisocyanate, phenylene diisocyanate, toluene diisocyanate (TDI), 4,4′-diphenyl methane diisocyanate (MDI), isophorone diisocyanate amp and bis-(4-isocyanato cyclohexyl)methane. Examples of polyol include polyether polyol, polycarbonate polyol and polyester polyol.

Accordingly, when the resin (A) formed in the step (3) is one of the various polyurethane resins that are produced by reaction between polyisocyanate and polyol, the above examples of polyisocyanate can be used as the monomer used in the separator forming composition prepared in the step (1), and the above examples of polyol can be used as the oligomer used in the separator forming composition prepared in the step (1).

Further, when forming each of the above examples of the resin (A), a monofunctional monomer such as isobornyl acrylate, methoxy polyethylene glycol acrylate or phenoxy polyethylene glycol acrylate can be used in combination. Accordingly, when the resin (A) formed in the step (3) includes a structural portion derived from any of these monofunctional monomers, the above examples of monofunctional monomer can be used as the monomer in the separator forming composition prepared in the step (1) in combination with the above examples of other monomers and oligomers.

Generally, an energy ray-sensitive polymerization initiator is included in the separator forming composition. Specific examples of the polymerization initiator include bis(2,4,6-trimethylbenzoyl)phenylphosphine oxide, 2,2-dimethoxy-2-phenylacetophenone, and 2-hydroxy-2-methylpropiophenone. The amount of the polymerization initiator used is preferably 1 to 10 parts by mass with respect to 100 parts by mass of the total amount of the monomer and the oligomer (in the case of using only one of the monomer and the oligomer, the amount thereof).

In the step (1) of preparing the separator forming composition, the solvent (a) capable of dissolving the resin raw material and the solvent (b) capable of causing the resin raw material to agglomerate by solvent shock are used as solvents.

Since the solvent (a) can dissolve the resin raw material, such as the monomer or the oligomer, contained in the separator forming composition in a favorable manner, a coating formed in the step (2) by applying the separator forming composition to a substrate becomes highly uniform, improving the uniformity of the separator. On the other hand, the resin raw material in the separator forming composition agglomerates some what due to solvent shock brought by the action of the solvent (b). Here, the agglomeration of the resin raw material in the separator forming composition occurs to such extent that it does not impair the uniformity of the coating formed in the step (2) and allows fine pores to be formed uniformly in the coating when the resin (A) is formed by energy irradiation in the step (3). Consequently, when the solvents (a) and (b) are removed by drying in the subsequent step (4), a number of fine and uniform pores are formed in the separator. Thus, the separator produced by the method of the present invention has excellent lithium ion permeability and excellent resistance to short-circuiting at the time of charging.

The solvent (a) used in the separator forming composition can dissolve the resin raw material such as the monomer or the oligomer in a favorable manner. To be more specific, the solvent (a) is preferably a solvent having a solubility parameter (hereinafter referred to as an “SP value”) of, for example, 8.9 or more.

However, when the SP value of the solvent (a) is too high, the resin (A) formed in the step (3) may swell or dissolve. This may cause a decline in the effect of forming a number of fine and uniform pores in the separator produced by the method of the present invention. For this reason, the SP value of the solvent (a) is preferably 9.9 or less.

Specific examples of the solvent (a) include toluene (SP value: 8.9), butyl aldehyde (SP value: 9.0), ethyl acetate (SP value: 9.0), ethyl acetate (SP value: 9.1), tetrahydrofuran (SP value: 9.1), benzene (SP value: 9.2), methyl ethyl ketone (SP value: 9.3), benzaldehyde (SP value: 9.4), chlorobenzene (SP value: 9.5), ethylene glycol monobutyl ether (SP value: 9.5), 2-ethyl hexanol (SP value: 9.5), methyl acetate (SP value: 9.6), dichloroethyl ether (SP value: 9.8), 1,2-dichloroethane (SP value: 9.8), acetone (SP value: 9.8), and cyclohexanone (SP value: 9.9).

When being added to a resin raw material solution containing the resin raw material and the solvent (a), the solvent (b) of the separator forming composition can cause the resin raw material to agglomerate by solvent shock. The SP value of the solvent (b) is preferably more than 10 and 15 or less.

Specific examples of the solvent (b) include acetic acid (SP value: 10.1), m-cresol (SP value: 10.2), aniline (SP value: 10.3), i-octanol (SP value: 10.3), cyclopentanone (SP value: 10.4), ethylene glycol monoethyl ether (SP value: 10.5), t-butyl alcohol (SP value: 10.6), pyridine (SP value: 10.7), propionitrile (SP value: 10.8), N,N-dimethyl acetamide (SP value: 10.8), 1-pentanol (SP value: 10.9), nitroethane (SP value: 11.1), furfural (SP value: 11.2), 1-butanol (SP value: 11.4), cyclohexanol (SP value: 11.4), isopropanol (SP value: 11.5), acetonitrile (SP value: 11.9), N,N-dimethyl formamide (SP value: 11.9), benzyl alcohol (SP value: 12.1), diethylene glycol (SP value: 12.1), ethanol (SP value: 12.7), dimethyl sulfoxide (SP value: 12.9), 1,2-propylene carbon acid (SP value: 13.3), N-ethyl formamide (SP value: 13.9), ethylene glycol (SP value: 14.1), and methanol (SP value: 14.5).

In terms of favorably ensuring the effect of forming a number of fine and uniform pores in the separator resulting from use of the solvent (b), V_{sb}/Vₛₐ as a ratio between the volume Vₛₐ of the solvent (a) and the volume V_{sb} of the solvent (b) used in the separator forming composition is set to 0.04 to 0.2.

Note that it is still possible to produce a separator having fine and uniform pores with the use of only the solvent (a) and no solvent (b) by including a pore forming assistant such as inorganic fine particles in the separator forming composition. However, since the solvents (a) and (b) are used in combination in the method of the present invention as solvents for use in the separator forming composition, a separator having a number of fine and uniform pores can be produced without using such a pore forming assistant.

The separator of the present invention may also include inorganic fine particles (B). The inclusion of the inorganic fine particles (B) leads to a further improvement in the strength and the dimensional stability of the separator.

To produce a separator containing the inorganic fine particles (B) by the method of the present invention, the inorganic fine particles (B) may be included in the separator forming composition.

Specific examples of the inorganic fine particles (B) include: fine particles of inorganic oxides such as iron oxide, silica (SiO_{z}), alumina (Al₂O₃), TiO₂ (titania) and BaTiO₃; fine particles of inorganic nitrides such as aluminum nitride and silicon nitride; fine particles of hardly soluble ionic crystals such as calcium fluoride, barium fluoride and barium sulfate; fine particles of covalent crystals such as silicon and diamond; and fine particles of clays such as montmorillonite. Here, the inorganic oxide fine particles may be fine particles of materials derived from mineral resources such as boehmite, zeolite, apatite, kaolin, mullite, spinel, olivine and mica, or artificial products thereof. Further, the inorganic fine particles (B) may be electrically insulating particles obtained by coating, with a material having electrical insulation (e.g., any of the above inorganic oxides), the surface of a conductive material, exemplified by conductive oxides such as metal, SnO₂ and indium tin oxide (ITO) and carbonaceous materials such as carbon black and graphite. The above examples of the inorganic fine particles may be used alone or in combination of two or more. Among the above examples of inorganic fine particles, inorganic oxide fine particles are more preferable, and fine particles of alumina, titania, silica and boehmite are even more preferable.

The average particle size of the inorganic fine particles (B) is preferably 0.001 μm or more, and more preferably 0.1 μm or more, and is preferably 15 μm or less, and more preferably 1 μm or less. Note that the average particle size of the inorganic fine particles (B) can be defined as a number average particle size measured by dispersing the inorganic fine particles (B) in a medium that does not dissolve the inorganic fine particles (B) using, for example, a laser scattering particle size distribution analyzer (e.g., “LA-920” manufactured by Horiba, Ltd.) [the average particle size of the inorganic fine particles (B) in each Example (described later) was measured by this method].

Further, the inorganic fine particles (B) may have a form close to sphere or may have a plate-like or fibrous shape, for example. However, in terms of improving the resistance of the separator to short-circuiting, the inorganic fine particles (B) are preferably plate-like particles or particles having a secondary particle structure formed by agglomeration of primary particles. In particular, particles having a secondary particle structure formed by agglomeration of primary particles are more preferable in terms of improving the porosity of the separator. Typical examples of the plate-like particles and secondary particles include platelike alumina and plate-like boehmite, alumina in the form of secondary particles, and boehmite in the form of secondary particles.

When including the inorganic fine particles (B) in the separator of the present invention, V_{A}/V_{B} as the ratio between the volume V_{A} of the resin (A) and the volume V_{B} of the inorganic fine particles (B) is preferably 0.6 or more, and more preferably 3 or more. When V_{A}/V_{B} is within the range of above values, the occurrence of defects such as cracks can be suppressed more favorably by the action of the highly flexible resin (A) even if the separator is bent to form a wound electrode group (especially a wound electrode group having a flat transverse section used in, for example, a rectangular battery), for example. Thus, the resistance of the separator to short-circuiting can be further improved.

Further, when including the inorganic fine particles (B) in the separator of the present invention, V_{A}/V_{B} is preferably 9 or less, and more preferably 8 or less. When V_{A}/V_{B} is within the range of above values, the effect of improving the strength of the separator and the effect of improving the dimensional stability of the separator resulting from the inclusion of the inorganic fine particles (B) can be produced more favorably.

Furthermore, when including the inorganic fine particles in the separator of the present invention, it is preferable that the separator consists primarily of the resin (A) and the inorganic fine particles (B) when using no porous base (described later) composed of a fibrous material (C). Specifically, the total volume of the resin (A) and the inorganic fine particles (B) (V_{A}+V_{B}) is preferably 50 vol % or more, and more preferably 70 vol % or more (also may be 100 vol %) of the entire volume (the volume excluding the pore portions: hereinafter, the same goes for the volume ratio between respective components of the separator) of the components of the separator. On the other hand, when using the porous base (described later) composed of the fibrous material (C) in the separator of the present invention, the total volume of the resin (A) and the inorganic fine particles (B) (V_{A}+V_{B}) is preferably 20 vol % or more, and more preferably 40 vol % or more of the entire volume of the components of the separator.

Therefore, when including the inorganic fine particles (B) in the separator forming composition, it is desirable that the amount of the inorganic fine particles (B) to be added is adjusted such that V_{A}/V_{B} will satisfy the above values and V_{A}+V_{B} will satisfy the above values in the separator produced.

Furthermore, the fibrous material (C) can also be included in the separator of the present invention. The inclusion of the fibrous material (C) also leads to a further improvement in the strength and the dimensional stability of the separator.

To produce a separator containing the fibrous material (C) by the method of the present invention, the fibrous material (C) may be included in the separator forming composition or a porous base composed of the fibrous material (C) may be used as a substrate to which the separator forming composition is to be applied.

There is no particular limitation to the properties of the fibrous material (C) as long as the fibrous material (C) has a heat-resistant temperature (a temperature at which no deformation is observed by visual inspection) of 150° C. or higher, has electrical insulation, is electrochemically stable, and is stable in the nonaqueous electrolyte of an electrochemical device and the solvents used in the production of the separator. The term “fibrous material” as used herein refers to one having an aspect ratio (length in the longitudinal direction/width (diameter) in the direction perpendicular to the longitudinal direction) of 4 or more. The aspect ratio is preferably 10 or more.

Specific examples of constituents of the fibrous material (C) include; cellulose and its modified products (e.g., carboxymethyl cellulose (CMC) and hydroxypropyl cellulose (HPC)); resins such as polyolefin (e.g., polypropylene (PP) and a propylene copolymer), polyester (e.g., polyethylene terephthalate (PET), polyethylene naphthalate (PEN), and polybutylene terephthalate (PBT)), polyacrylonitrile (PAN), polyaramide, polyamide imide and polyimide; and inorganic oxides such as glass, alumina, zirconia and silica. Two or more of these constituents may be included. Further, the fibrous material (C) may also contain a variety of known additives (e.g., an antioxidant in the case of a resin fibrous material) as needed.

Further, the diameter of the fibrous material (C) may be less than or equal to the thickness of the separator, and is preferably 0.01 to 5 μm, for example. When the fiber diameter is too large, entanglement of the fibrous material becomes insufficient. Thus, when the fibrous material is used to form a sheet material to be used as the base of the separator, the strength of the base may decline and it becomes difficult to handle the base. Further, when the diameter is too small, the pores in the separator become too small, which may reduce the effect of improving the lithium ion permeability.

The fibrous material (C) is present in the separator such that the angle between the separator surface and the major axis (i.e., the axis in the longitudinal direction) of the fibrous material (C) is, on average, preferably 30° or less, and more preferably 20° or less.

For example, the content of the fibrous material (C) in the separator is preferably 10 vol % or more, and more preferably 20 vol % or more of the entire components. Note that the content of the fibrous material (C) in the separator is preferably 70 vol % or less, and more preferably 60 vol % or less. However, when using the fibrous material (C) in the form of a porous base (described later), the content of the fibrous material (C) is preferably 90 vol % or less, and more preferably 80 vol % or less.

Thus, when including the fibrous material (C) in the separator forming composition, it is desirable to adjust the amount of the fibrous material (C) to be added or the amount of the separator forming composition to be applied to the surface of the porous base composed of the fibrous material (C) such that the content of the fibrous material (C) in the separator produced will satisfy the above values.

Further, it is preferable that the separator of the present invention has the shutdown function in terms of further improving the level of safety of an electrochemical device in which the separator is to be used. To provide the separator with the shutdown function, for example, a thermoplastic resin having a melting point of 80° C. or higher and 140° C. or lower [hereinafter, referred to as the “heat-melting resin (D)”] or a resin that swells by absorbing a liquid nonaqueous electrolyte (a nonaqueous electrolyte, hereinafter, may simply be referred to as an “electrolyte”) when heated, and whose degree of swelling increases with an increase in the temperature (hereinafter, referred to as the “heat-swelling resin (E)”) may be included in the separator. In a separator that has been provided with the shutdown function by the above-described method, when heat is generated in the electrochemical device, the heat-melting resin (D) melts and closes the pores of the separator, or the heat-swelling resin (E) absorbs the nonaqueous electrolyte (liquid nonaqueous electrolyte) in the electrochemical device, causing a shutdown that suppresses the progress of electrochemical reactions.

To produce a separator containing the heat-melting resin (D) and/or the heat-swelling resin (E) by the method of the present invention, the heat-melting resin (D) and/or the heat-swelling resin (E) may be included in the separator forming composition.

The heat-melting resin (D) is a resin that has a melting point, namely, a melting temperature measured with a DSC in accordance with JIS K 7121 of 80° C. or higher and 140° C. or lower. The heat-melting resin (D) is preferably a material that has electrical insulation, is stable in the nonaqueous electrolyte of an electrochemical device and the solvents used in the production of the separator, and is further electrochemically stable and cannot be easily oxidized or reduced in the operating voltage range of the electrochemical device. Specific examples of the heat-melting resin (D) include polyethylene (PE), polypropylene (PP), copolymerized polyolefin, a polyolefin derivative (such as chlorinated polyethylene), a polyolefin wax, a petroleum wax and a carnauba wax. Examples of the copolymerized polyolefin include a copolymer of ethylene-vinyl monomer, more specifically, ethylene-acrylic acid copolymers such as an ethylene-propylene copolymer, EVA, an ethylene-methyl acrylate copolymer and an ethylene-ethyl acrylate copolymer. It is desirable that the ethylene-derived structural unit of the copolymerized polyolefin is 85 mol % or more. Further, it is also possible to use polycycloolefin and the like. The above examples of the heat-melting resin (D) may be used alone or in combination of two or more.

Among the materials described above as the examples of the heat-melting resin (D), PE, a polyolefin wax, PP, or EVA whose ethylene-derived structural unit is 85 mol % or more can be used preferably. Further, as needed, the heat-melting resin (D) may also contain a variety of known additives (e.g., an antioxidant) added to resins.

As the heat-swelling resin (E), usually, a resin can be used that absorbs no electrolyte or only a limited amount of electrolyte in a temperature range (about 70° C. or lower) in which batteries are used, and therefore has a degree of swelling lower than or equal to a prescribed degree, but when heated to a required temperature (Tc), significantly swells by absorbing an electrolyte and whose degree of swelling increases with an increase in the temperature. In an electrochemical device using a separator containing the heat-swelling resin (E), flowable electrolyte that is not absorbed by the heat-swelling resin (E) is present in the pores of the separator at temperatures lower than Tc, and therefore the lithium ion conductivity inside the separator increases, making it possible to achieve an electrochemical device with favorable load characteristics. On the other hand, when heated to a temperature higher than or equal to the temperature at which the property that the degree of swelling increases with an increase in the temperature (hereinafter, may be referred to as the “heat-swelling property”) is exhibited, the heat-swelling resin (E) significantly swells by absorbing the electrolyte contained in the device, and the swelled heat-swelling resin (E) closes the pores of the separator, and at the same time, the amount of flowable electrolyte decreases, leading to electrolyte deficiency in the electrochemical device. This suppresses the reaction between the electrolyte and the active materials, thus further improving the level of safety of the electrochemical device. Moreover, if the temperature is elevated and becomes higher than Tc, the above-mentioned electrolyte deficiency advances further by the heat-swelling property to suppress the battery reaction even further, which in return makes it possible to further improve the level of safety at elevated temperatures.

The temperature at which the heat-swelling resin (E) starts to exhibit the heat-swelling property is preferably 75° C. or higher. This is because, by setting the temperature at which the heat-swelling resin (E) starts to exhibit the heat-swelling property to 75° C. or higher, the temperature (Tc) at which the internal resistance of the device increases due to a significant decrease in the Li ion conductivity can be set to about 80° C. or higher. On the other hand, the higher the lower limit of the temperature at which the heat-swelling property is exhibited, the higher Tc of the separator becomes. Thus, in order to set Tc to about 130° C. or lower, the temperature at which the heat-swelling resin (E) starts to exhibit the heat-swelling property is preferably 125° C. or lower, and more preferably 115° C. or lower. If the temperature at which the heat-swelling property is exhibited is too high, the effect of improving the level of safety of the electrochemical device may not be ensured sufficiently because the thermal runaway reaction of the active materials inside the device cannot be suppressed adequately. Further, if the temperature at which the heat-swelling property is exhibited is too low, the lithium ion conductivity may be reduced excessively in a normal working temperature range (about 70° C. or lower) of the electrochemical device.

Further, it is desirable that the heat-swelling resin (E) absorbs electrolyte as little as possible and undergoes little swelling at a temperature lower than the temperature at which the heat-swelling property is exhibited. This is because the electrochemical device exhibits more favorable characteristics such as load characteristics in the working temperature range of the electrochemical device, for example, at ambient temperature if the electrolyte is retained in a flowable state in the pores of the separator than when it is incorporated into the heat-swelling resin (E).

The amount of the electrolyte absorbed by the heat-swelling resin (E) at room temperature (25° C.) can be evaluated using the degree of swelling B_{R} defined by Formula (1) below, which represents a volume change of the heat-swelling resin (E).

B_{R}=(V₀/Vᵢ)−1 (1)

[where V₀ represents the volume (cm³) of the heat-swelling resin (E) after being immersed in an electrolyte at 25° C. for 24 hours, and Vᵢ represents the volume (cm³) of the heat-swelling resin (E) before being immersed in the electrolyte].

When including the heat-swelling resin (E) in the separator of the present invention, the degree of swelling B_{R} of the heat-swelling resin (E) at room temperature (25° C.) is preferably 1 or less. It is desirable that the swelling as a result of absorbing electrolyte is small, or in other words, B_{R} has a small value as close as possible to 0. It is also desirable that at temperatures lower than the temperature at which the heat-swelling property is exhibited, the change in the degree of swelling with temperature is as small as possible.

On the other hand, as the heat-swelling resin (E), a resin can be used that absorbs an increased amount of electrolyte when heated to a temperature equal to or higher than the lower limit of the temperature at which the heat-swelling property is exhibited, and whose degree of swelling increases with temperature in a temperature range in which the heat-swelling property is exhibited. For example, it is preferable to use a heat-swelling resin whose degree of swelling B_{T} that is measured at 120° C. and defined by Formula (2) below is 1 or more.

B_{T}=(V₁/V₀)−1 (2)

[where V₀ represents the volume (cm³) of the heat-swelling resin (E) after being immersed in an electrolyte at 25° C. for 24 hours, and V₁ represents the volume (cm³) of the heat-swelling resin (E) after the heat-swelling resin (E) is immersed in the electrolyte at 25° C. for 24 hours, the electrolyte is then heated to 120° C., and held at 120° C. for one hour].

On the other hand, it is desirable that the degree of swelling of the heat-swelling resin (E) defined by Formula (2) above is 10 or less because too large a degree of swelling may cause deformation of the electrochemical device.

The degree of swelling defined by Formula (2) above can be estimated by directly measuring the change in size of the heat-swelling resin (E), for example, using the light-scattering method and image analysis of an image captured with a CCD camera or the like, but can be measured more accurately using, for example, the following method.

Using a binder resin whose degrees of swelling at 25° C. and 120° C. that are defined as in Formulas (1) and (2) above are known, the heat-swelling resin (E) is mixed with a solution or emulsion of the binder resin to prepare a slurry. This slurry is applied onto a substrate, such as a PET sheet or a glass plate, to form a film, and the mass of the film is measured. Next, this film is immersed in an electrolyte at 25° C. for 24 hours and the mass of the film is measured. Furthermore, the electrolyte is heated to 120° C. and the mass is measured after maintaining the temperature at 120° C. for one hour, and the degree of swelling B_{T} is calculated using Formulas (3) to (9) below. It is assumed that the increase in volume of the components other than the electrolyte during the temperature increase from 25° C. to 120° C. can be ignored in Formulas (3) to (9) below.

Vᵢ=Mᵢ×W/P_{A} (3)

V_{b}=(M_{O}−Mᵢ)/P_{B} (4)

V_{C}=M_{I}/P_{C}−M_{O}/P_{B} (5)

V_{V}=Mᵢ×(1−W)/P_{V} (6)

V_{O}=Vᵢ+V_{b}−V_{V}×(B_{B}+1) (7)

V_{D}=V_{V}×(B_{B}+1) (8)

B_{T}={V_{O}+V_{C}−V_{D}×(B_{C}+1)}/V_{O}−1 (9)

Here, in Formulas (3) to (9) above,

Vᵢ: the volume (cm³) of the heat-swelling resin (E) before being immersed in an electrolyte,

V_{O}: the volume (cm³) of the heat-swelling resin (E) after being immersed in the electrolyte at 25° C. for 24 hours,

V_{b}: the volume (cm³) of the electrolyte absorbed in the film after being immersed in the electrolyte at room temperature for 24 hours,

V_{C}: the volume (cm³) of the electrolyte absorbed in the film during a period in which the film is immersed in the electrolyte at room temperature for 24 hours, the electrolyte is heated to 120° C., and is held at 120° C. for one hour,

V_{V}: the volume (cm³) of the binder resin before being immersed in the electrolyte,

V_{D}: the volume (cm³) of the binder resin after being immersed in the electrolyte at room temperature for 24 hours,

Mᵢ: the mass (g) of the film before being immersed in the electrolyte,

M_{O}: the mass (g) of the film after being immersed in the electrolyte at room temperature for 24 hours,

M_{I}: the mass (g) of the film after the film is immersed in the electrolyte at room temperature for 24 hours, then the electrolyte is heated to 120° C., and held at 120° C. for one hour,

W: the mass ratio of the heat-swelling resin (E) contained in the film before being immersed in the electrolyte,

P_{A}: the specific gravity (g/cm³) of the heat-swelling resin (E) before being immersed in the electrolyte,

P_{B}: the specific gravity (g/cm³) of the electrolyte at room temperature,

P_{C}: the specific gravity (g/cm³) of the electrolyte at a predetermined temperature,

P_{V}: the specific gravity (g/cm³) of the binder resin before being immersed in the electrolyte,

B_{B}: the degree of swelling of the binder resin after being immersed in the electrolyte at room temperature for 24 hours, and

B_{C}: the degree of swelling of the binder resin defined by Formula (2) above when heated.

Further, with the use of Vᵢ and V_{O} determined from Formulas (3) and (7) above by the above-described method, the degree of swelling B_{R}, at room temperature can be determined using Formula (1) above.

As with conventionally known electrochemical devices, the electrochemical device of the present invention uses, for example, a solution in which a lithium salt is dissolved in an organic solvent as the nonaqueous electrolyte (the type of the lithium salt and the organic solvent, the concentration of the lithium salt, and other details will be described later). Accordingly, as the heat-swelling resin (E), it is recommended using a resin that starts exhibiting the above-described heat-swelling property upon reaching any temperature in the range from 75 to 125° C. in a solution in which a lithium salt is dissolved in an organic solvent, and that can swell such that the degrees of swelling B_{R} and B_{T} in the solution preferably satisfy the above-described values.

The heat-swelling resin (E) preferably is a material that has heat resistance and electrical insulation, is stable in electrolytes, and cannot be easily oxidized or reduced in an operating voltage range of batteries and thus is electrochemically stable. An example of such a material is a crosslinked resin. Specific examples include: at least one crosslinked resin selected from the group consisting of styrene resins [such as polystyrene (PS)], styrene butadiene rubber (SBR), acrylic resins [such as polymethylmethacrylate (PMMA)], polyalkylene oxides [such as polyethylene oxide (PEO)], fluorocarbon resins [such as polyvinylidene fluoride (PVDF)], and derivatives thereof, urea resin; and polyurethane. As the heat-swelling resin (E), the above examples of resin may be used alone or in combination of two or more. Further, the heat-swelling resin (E) may contain a variety of known additives that are added to resins, including, for example, an antioxidant, as needed.

Among the above-described constituents, it is preferable to use crosslinked styrene resin, crosslinked acrylic resin and crosslinked fluorocarbon resin, and crosslinked PMMA is particularly preferable.

Although the mechanism with which these crosslinked resins absorb an electrolyte and swell with increasing temperature is not clearly known, it is considered that there is a correlation with glass transition temperature (Tg). Specifically, it seems that, generally, resins become flexible when heated to their Tg, and thus, resins as listed above can absorb a large amount of electrolyte at a temperature higher than or equal to their Tg, and as a result, swell. Accordingly, it is desirable to use, as the heat-swelling resin (E), a crosslinked resin having a Tg of approximately 75 to 125° C., considering the fact that the temperature at which the shutdown effect actually occurs is somewhat higher than the temperature at which the heat-swelling resin (E) starts exhibiting the heat-swelling property. Note that the Tg of a crosslinked resin serving as the heat-swelling resin (E) as used herein is a value measured with a DSC in accordance with JIS K 7121.

The above-described crosslinked resins have a certain degree of reversibility in volume change resulting from temperature change in a so-called dry state before they incorporate an electrolyte. More specifically, the crosslinked resins expand with increasing temperature, but again contract when the temperature is lowered. In addition, they have a heat resistance temperature much higher than the temperature at which the heat-swelling property is exhibited, and therefore, even if the lower limit of the temperature at which the heat-swelling property is exhibited is about 100° C., it is possible to select a material that can be heated to 200° C. or higher. Accordingly, the resin will not melt and the heat-swelling property of the resin will not be impaired even when the resins are heated in a separator production process or the like, which facilitates handling in the production process that involves an ordinary heating process.

Although the form of the heat-melting resin (D) and the heat-swelling resin (E) [hereinafter, the heat-melting resin (D) and the heat-swelling resin (E) may be collectively referred to as a “shutdown resin”] is not particularly limited, it is preferable to use them in the form of fine particles. It is sufficient that the particle size of the fine particles in a dry state is smaller than the thickness of the separator, and their average particle size is preferably 1/100 to ⅓ of the thickness of the separator. Specifically, the average particle size is preferably 0.1 to 20 μm. When the particle size of the shutdown resin particles is too small, the gap between the particles is excessively reduced and the ion conduction path is increased, which may degrade the characteristics of the electrochemical device. Further, when the particle size of the shutdown resin particles is too large, the gap is increased, which may reduce the effect of improving the resistance to short-circuiting caused by lithium dendrites and the like. Note that the average particle size of the shutdown resin particles can be defined as a number average particle size, measured using, for example, a laser diffraction particle size analyzer (e.g., “LA-920” manufactured by Horiba, Ltd.) by dispersing the fine particles in a medium (e.g., water) that does not cause swelling of the shutdown resin.

The shutdown resin may be in a different form from the one above described, and may be present in a state in which it is deposited on the surface of any of the other components including, for example, the inorganic fine particles or the fibrous material and thus integrated with the constituent. Specifically, the shutdown resin may be present as particles having a core-shell structure in which the inorganic fine particles serve as the core and the shutdown resin serves as the shell. Alternatively, the shutdown resin may be present in the form of fibers having a multilayered structure including the shutdown resin on the surface of a core material.

To achieve the shutdown effect more easily, the content of the shutdown resin in the separator is, for example, preferably as follows. The volume of the shutdown resin is preferably 10 vol % or more, and more preferably 20 vol % or more of the entire volume of the components of the separator. On the other hand, in terms of ensuring the shape stability of the separator at elevated temperatures, the volume of the shutdown resin is preferably 50 vol % or less, and more preferably 40 vol % or less of the entire volume of the components of the separator.

Thus, when including the shutdown resin in the separator forming composition, it is desirable to adjust the amount of the shutdown resin to be added such that the content of the shutdown resin in the separator produced will satisfy the above values.

The solid content of the separator forming composition including the oligomer or the monomer, the polymerization initiator, and optionally the inorganic fine particles (B) and the like is preferably, for example, 10 to 50 mass %.

In the step (2) of the method of the present invention, the separator forming composition prepared in the step (1) is applied to a substrate to form a coating.

For example, an electrode for an electrochemical device (a positive electrode or a negative electrode), a porous base, a base material such as a film or a metal foil can be used as the substrate to which the separator forming composition is to be applied.

When using an electrode for an electrochemical device as the substrate, it is possible to produce the separator integral with the electrode. Further, when using a porous base as the substrate, it is possible to produce the separator having a multilayered structure composed of the porous base and a layer made of the separator forming composition. Furthermore, when using a base material such as a film or a metal foil as the substrate, it is possible to produce the separator in the form of an independent film by separating the produced separator from the base material.

Examples of the porous base used as the substrate include porous sheets such as a woven fabric made of at least one type of fibrous material including, as a component, any of the materials described above as their examples, and a nonwoven fabric having a structure in which the fibrous material is entangled. More specific examples include paper, a PP nonwoven fabric, polyester nonwoven fabrics (such as a PET nonwoven fabric, a PEN nonwoven fabric and a PBT nonwoven fabric) and a PAN nonwoven fabric.

Further, microporous films (e.g., microporous films made of polyolefin such as PE and PP) generally used as separators for electrochemical devices such as nonaqueous electrolyte secondary batteries also can be used as the porous base. The use of such a porous base can also provide the separator with the shutdown function. Note that such a porous base generally has small heat resistance, so that it may shrink as the internal temperature of an electrochemical device increases, and that may lead to short-circuiting due to contact between the positive electrode and the negative electrode. However, in the case of the separator produced by the method of the present invention, a layer containing the resin (A) having excellent heat resistance is formed on the surface of such a porous base, and this layer can suppress the thermal shrinkage of the porous base. Accordingly, an electrochemical device having a high level of safety can be formed with the separator.

To apply the separator forming composition to the substrate, a variety of known application methods can be adopted. Further, when using an electrode for an electrochemical device or a porous base as the substrate, these substrates may be impregnated with the separator forming composition.

In the step (3) of the method of the present invention, a coating of the separator forming composition applied to the substrate is irradiated with energy rays to form the resin (A).

Examples of the energy ray with which a coating of the separator forming composition is irradiated include visible light, ultraviolet rays, radiation and electron beams. It is more preferable to use visible light or ultraviolet rays because they are safer to use.

It is preferable to appropriately adjust the conditions for energy ray irradiation, such as the wavelength, the irradiation strength and the irradiation time, so that the resin (A) can be formed favorably. Specifically, the wavelength of the energy ray can be set to 320 to 390 nm, and the irradiation strength can be set to 623 to 1081 mJ/cm². Note, however, that the conditions for energy ray irradiation are not limited to those described above.

In the step (4) of the method of the present invention, the solvents are removed from the energy ray-irradiated coating of the separator forming composition to form pores. The drying conditions (e.g., temperature, time, drying method) may be appropriately selected in accordance with the types of the solvents used in the separator forming composition such that they can be removed favorably. Specifically, the drying temperature can be set to 20 to 80° C., and the drying time can be set to 30 minutes to 24 hours. In addition to air drying, it is possible to use, as the drying method, a method using a thermostatic oven, a dryer, a hot plate (in the case of directly forming the separator on the electrode surface), or the like. Note, however, that the drying conditions in the step (4) are not limited to those described above.

When using a base material such as a film or a metal foil as the substrate, the separator formed through the step (4) is separated from the substrate and is used in the production of an electrochemical device, as described above. On the other hand, when using an electrode or a porous base as the substrate, the separator (or layer) formed may be used in the production of an electrochemical device without separating the separator (or layer) from the substrate.

Alternatively, the separator may be provided with the shutdown resin by forming a layer containing the above-described shutdown resin (e.g., a layer composed solely of the shutdown resin, a layer containing the shutdown resin and a binder, etc.) on one side or both sides of the separator produced.

In order to ensure the amount of electrolyte retained and to achieve favorable lithium ion permeability, the porosity of the separator of the present invention is preferably 10% or more in a dry state. On the other hand, in terms of ensuring the separator strength and preventing internal short-circuiting, the porosity of the separator is preferably 70% or less in a dry state. The porosity: P (%) of the separator in a dry state can be calculated by obtaining the total sum of components i using Formula (10) below from the thickness and the mass per area of the separator, and the density of the separator components.

P={1−(m/t)/(Σaᵢ·ρᵢ)}×100 (10)

Where, aᵢ is the ratio of component i to the total mass, where the total mass is taken as 1, ρᵢ is the density of the component i (g/cm³), m is the mass per unit area of the separator (g/cm²), and t is the thickness (cm) of the separator.

Further, the separator of the present invention desirably has a Gurley value of 10 to 300 sec. The Gurley value is obtained by a method according to JIS P 8117 and expressed as the length of time (seconds) it takes for 100 mL air to pass through a membrane at a pressure of 0.879 g/mm². If the Gurley value is too large, the lithium ion permeability may deteriorate. On the other hand, if the Gurley value is too small, the strength of the separator may decline. Furthermore, it is desirable that the separator has strength of 50 g or more, the strength being piercing strength obtained using a needle having a diameter of 1 mm. When lithium dendrites develop, the dendrites may penetrate the separator and cause short-circuiting if the piercing strength is too small. By being configured as above, the separator can have the Gurley value and the piercing strength as described above.

In terms of separating the positive electrode and the negative electrode with more certainty, the thickness of the separator of the present invention is preferably 6 μm or more, and more preferably 10 μm or more. On the other hand, when the thickness of the separator is too large, the energy density of a battery using the separator may decline. Therefore, the thickness is preferably 50 μm or less, and more preferably 30 μm or less.

As long as the electrochemical device of the present invention includes a positive electrode, a negative electrode, a separator and a nonaqueous electrolyte and the separator is the separator of the present invention, there is no particular limitation to the rest of the configuration and structure, and any of various configurations and structures adopted in conventionally known electrochemical devices can be applied to the electrochemical device.

The electrochemical device of the present invention encompasses a nonaqueous electrolyte primary battery; a supercapacitor, and the like, in addition to a nonaqueous electrolyte secondary battery; and preferably can be used especially for applications that require safety at elevated temperatures. The following detailed description is focused on a case where the electrochemical device of the present invention is a nonaqueous electrolyte secondary battery

The form of the nonaqueous electrolyte secondary battery may be cylindrical (e.g., rectangular cylindrical, circular cylindrical) using a steel can, an aluminum can or the like as an outer can. Further, the nonaqueous electrolyte secondary battery may be in the form of a soft package battery using a metal-evaporated laminate film as an outer package.

There is no particular limitation to the positive electrode, as long as it is a positive electrode used in conventionally known nonaqueous electrolyte secondary batteries, i.e., a positive electrode containing an active material capable of intercalating and deintercalating Li ions. Examples of usable active materials include: lithium-containing transition metal oxides having a layered structure represented by Li₁₊ₓMO₂ (−0.1<x<0.1, and M: Co, Ni, Mn, Al, Mg, etc.); lithium manganese oxides having a spinel structure such as LiMn₂O₄ and those obtained by partially replacing any of the elements of LiMn₂O₄ with another element; and olivine-type compounds represented by LiMPO₄ (M: Co, Ni, Mn, Fe, etc.). Specific examples of the lithium-containing transition metal oxides having a layered structure include, in addition to LiCoO₂ and LiNi₁₋ₓCo_{x-y}Al_{y}O₂ (0.1≦x≦0.3, 0.01≦y≦0.2), oxides containing at least Co, Ni and Mn (LiMn_{1/3}Ni_{1/3}Co_{1/3}O₂, LiMn_{5/12}Ni_{5/12}CO_{1/6}O₂, LiMn_{3/5}Ni_{1/5}Co_{1/5}O₂, etc.).

A carbon material such as carbon black can be used as a conductive assistant, and a fluororesin such as PVDF can be used as a binder. Using a positive electrode material mixture in which these materials are mixed with the active material, a positive electrode active material-containing layer is formed, for example, on a current collector.

A foil, a punched metal, a mesh, and an expanded metal made of metal such as aluminum can be used as a positive electrode current collector. Generally, an aluminum foil having a thickness of 10 to 30 μm is used preferably.

Generally, a positive electrode lead portion is provided in the following manner. At the time of the production of the positive electrode, the positive electrode active material-containing layer is not formed on a part of the current collector to leave it exposed, and this exposed portion serves as the lead portion. Note that there is no need for the lead portion to be integral with the current collector from the beginning, and may be provided by connecting an aluminum foil or the like to the current collector afterwards.

There is no particular limitation to the negative electrode, as long as it is a negative electrode used in conventionally known nonaqueous electrolyte secondary batteries, i.e., a negative electrode containing an active material capable of intercalating and deintercalating Li ions. As the active material, carbon-based materials capable of intercalating and deintercalating lithium, such as graphite, pyrolytic carbons, cokes, glassy carbons, calcinated organic polymer compounds, mesocarbon microbeads (MCMB) and carbon fibers can be used alone or in combination of two or more. It is also possible to use elements such as Si, Sn, Ge, Bi, Sb, and In and alloys thereof, lithium-containing nitrides, compounds capable of being charged and discharged at a low voltage close to that of a lithium metal such as oxides, and lithium metals and a lithium/aluminum alloy as the negative electrode active material. The negative electrode may be produced in such a manner that a negative electrode material mixture is obtained by adding a conductive assistant (e.g., a carbon material such as carbon black) and a binder such as PVDF appropriately to the negative electrode active material, and then formed into a compact (a negative electrode active material-containing layer), with a current collector serving as the core material. Alternatively, foils of the lithium metal or various alloys as described above can be used as the negative electrode alone or in the form of a laminate on a current collector.

When using a current collector for the negative electrode, a foil, a punched metal, a mesh, an expanded metal made of copper or nickel can be used. Generally, a copper foil is used as the current collector. When the thickness of the negative electrode as a whole is reduced to obtain a high energy density battery, an upper limit of the thickness of the negative electrode current collector is preferably 30 μm and a lower limit is desirably 5 μm. A negative electrode lead portion can be formed in the same manner as the positive electrode lead portion.

The positive electrode and the negative electrode as described above can be used in the form of a laminated electrode group obtained by laminating these electrodes through the separator of the present invention, or in the form of a wound electrode group obtained by further winding the laminated electrode group. Additionally, by the action of the highly flexible resin (A), the separator of the present invention also exhibits excellent resistance to short-circuiting when being bent. Thus, in the electrochemical device of the present invention using the separator of the present invention, this effect becomes more prominent in the case of using a wound electrode group that requires changing the shape of the separator. The effect becomes particularly prominent in the case of using a flat wound electrode group (wound electrode group having a flat transverse section) that requires bending the separator with a strong force.

A solution (electrolyte) obtained by dissolving a lithium salt in an organic solvent is used as the nonaqueous electrolyte. There is no particular limitation to the lithium salt as long as it can dissociate in the solvent into Li⁺ ions and is less likely to cause side reactions such as decomposition in a voltage range where the battery is used. Examples of usable lithium salts include inorganic lithium salts such as LiClO₄, LiPF₆, LiRF₄, LiAsF₆, and LiSbF₆, and organic lithium salts such as LiCF₃SO₃, LiCF₃CO₂, Li₂C₂F₄(SO₃)₂, LiN(CF₃SO₂)₂, LiC(CF₃SO₂)₃, LiCₙF₂ₙ₊₁SO₃ (n≧2) and LiN(RfOSO₂)₂ (where Rf is a fluoroalkyl group).

There is no particular limitation to the organic solvent used for the nonaqueous electrolyte as long as the organic solvent dissolves the above-listed lithium salts and does not cause side reactions such as decomposition in a voltage range where the battery is used. Examples of the organic solvent include: cyclic carbonates such as ethylene carbonate, propylene carbonate, butylene carbonate and vinylene carbonate; chain carbonates such as dimethyl carbonate, diethyl carbonate, and methyl ethyl carbonate; chain esters such as methyl propionate; cyclic esters such as γ-butyrolactone; chain ethers such as dimethoxyethane, diethyl ether, 1,3-dioxolane, diglyme, triglyme and tetraglyme; cyclic ethers such as dioxane, tetrahydrofuran and 2-methyltetrahydrofuran; nitriles such as acetonitrile, propionitrile and methoxy propionitrile; and sulfite esters such as ethylene glycol sulfite, and they can be used in combination of two or more. To achieve a battery with more favorable characteristics, it is desirable to use a combination of the above organic solvents from which high conductivity can be achieved, such as a mixed solvent of an ethylene carbonate and a chain carbonate. Further, for the purpose of improving the characteristics of the battery such as the level of safety, charge-discharge cycle characteristics and high-temperature storability, additives such as vinylene carbonates, 1,3-propane sultone, diphenyl disulfide, cyclohexane, biphenyl, fluorobenzene and t-butyl benzene can be added to the nonaqueous electrolyte as needed.

The concentration of the lithium salt in the nonaqueous electrolyte is preferably 0.5 to 1.5 mol/L, and more preferably 0.9 to 1.3 mol/L.

The above-described nonaqueous electrolyte may also be used in the form of a gel (gel electrolyte) by adding a known gelling agent such as a polymer to the nonaqueous electrolyte.

### EXAMPLES

Hereinafter, the present invention will be described in detail by way of Examples. Note that the present invention is not limited to Examples described below.

### Example 1

### Production of Separator

To 7.2 parts by mass of urethane acrylate serving as an oligomer, 2 parts by mass of dipentoxylated pentaerythritol diacrylate serving as a monomer, 0.3 parts by mass of bis(2,4,6-trimethylbenzoyl)phenylphosphine oxide serving as a photoinitiator, 24 parts by mass of boehmite (average particle size: 0.6 μm) serving as the inorganic fine particles (B), 61 parts by mass of methyl ethyl ketone (SP value: 9.3) serving as the solvent (a), and 5.6 parts by mass of ethylene glycol (SP value: 14.1) serving as the solvent (b), zirconia beads having a diameter of 1 mm were added in an amount as 5 times (on a mass basis) as large as that of boehmite. All were uniformly stirred for 15 hours using a ball mill and then filtrated to prepare a separator forming slurry. V_{sb}/Vₛₐ as the volume ratio between the solvents (a) and (b) used in the separator forming slurry was 0.127.

The slurry was applied to a 12-μm thick non-woven fabric made of PET by dip coating by passing the non-woven fabric through the slurry. Then, the non-woven fabric was passed through a gap having a predetermined space. Subsequently, the non-woven fabric was irradiated with ultraviolet rays having a wavelength of 365 nm at an illuminance of 1081 mW/cm² for 10 seconds, followed by drying, to yield a separator having a thickness of 20 μm. V_{A}/V_{B} as the volume ratio between the volume V_{A} of the resin (A) and the volume V_{B} of the inorganic fine particles (B) in this separator was 1.22.

<Production of Positive Electrode>

Using N-methyl-2-pyrrolidone (NMP) as a solvent, 90 parts by mass of LiCoO₂ serving as a positive electrode active material, 7 parts by mass of acetylene black serving as a conductive assistant, and 3 parts by mass of PVDF serving as a binder were uniformly mixed to prepare a positive electrode material mixture-containing paste. This paste was applied intermittently onto both sides of a 15-μm thick aluminum foil, which would serve as a current collector, such that the application length was 280 mm on the front side and 210 mm on the backside, followed by drying. Then, calendering was performed so as to adjust the total thickness of the positive electrode active material-containing layers to 150 μm, and cutting was performed so as to bring the width thereof to 43 mm. Thus, a positive electrode was produced. Thereafter, a tab was attached to an exposed portion of the aluminum foil of the positive electrode.

<Production of Negative Electrode>

Using NMP as a solvent, 95 parts by mass of graphite serving as a negative electrode active material and 5 parts by mass of PVDF were uniformly mixed to prepare a negative electrode material mixture-containing paste. This paste was applied intermittently onto both sides of a 10-μm thick current collector made of a copper foil such that the application length was 290 mm on the front side and 230 mm on the backside, followed by drying. Then, calendering was performed so as to adjust the total thickness of the negative electrode active material-containing layers to 142 μm, and cutting was performed so as to bring the width thereof to 45 mm. Thus, a negative electrode was produced. Thereafter, a tab was attached to an exposed portion of the copper foil of the negative electrode.

<Assembly of Battery>

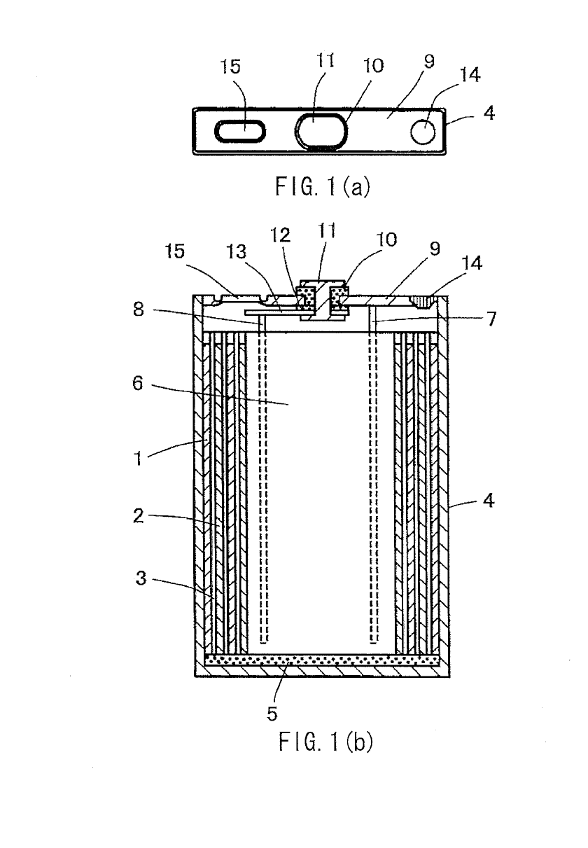

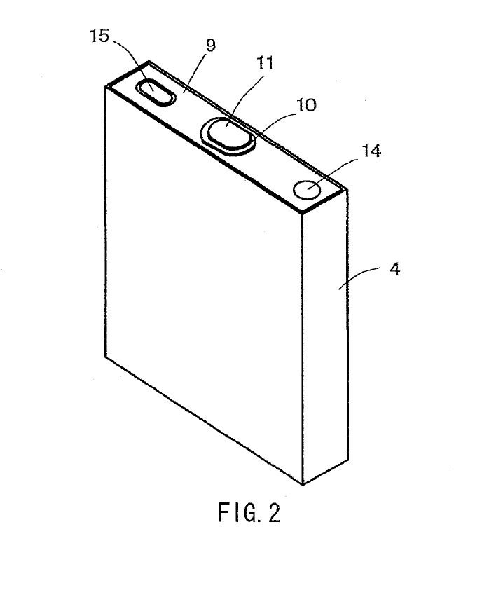

The thus obtained positive electrode and negative electrode were placed upon each other with the above-described separator interposed therebetween, and wound in a spiral fashion to produce a wound electrode group. The obtained wound electrode group was pressed into a flat shape, and placed in an aluminum outer can having a thickness of 4 mm, a height of 50 mm and a width of 34 mm. A nonaqueous electrolyte (obtained by dissolving LiPF₆ at a concentration of 1.2 mol/L in a solvent in which ethylene carbonate and ethyl methyl carbonate were mixed at a volume ratio of 1:2) was injected into the outer can, and then the outer can was sealed. Thus, a rectangular nonaqueous electrolyte secondary battery having the structure as shown in FIG. 1 and the external appearance as shown in FIG. 2 was produced.

Here, the battery shown in FIGS. 1 and 2 will be explained. A positive electrode 1 and a negative electrode 2 are housed in a rectangular outer can 4, along with a nonaqueous electrolyte, as a wound electrode group 6, which has been wound in a spiral fashion through a separator 3 as described above. However, in order to simplify the illustrations of FIG. 1, the metal foils as current collectors used in the production of the positive electrode 1 and the negative electrode 2 and the nonaqueous electrolyte are not illustrated.

The outer can 4 is made of aluminum alloy, and constitutes an outer package of the battery. The outer can 4 also serves as a positive electrode terminal. An insulator 5 composed of a polyethylene sheet is placed on the bottom of the outer can 4, and a positive electrode current collector plate 7 and a negative electrode current collector plate 8 connected to the ends of the positive electrode 1 and the negative electrode 2, respectively, are drawn from the electrode group 6 composed of the positive electrode 1, the negative electrode 2 and the separator 3. A stainless steel terminal 11 is attached to a cover plate 9 made of aluminum alloy for sealing the opening of the outer can 4 through a polypropylene insulating packing 10, and a stainless steel lead plate (electrode terminal current collecting mechanism) 13 is attached to the terminal 11 through an insulator 12.

The cover plate 9 is inserted in the opening of the outer can 4. By welding the junction of the cover plate 9 and the opening, the opening of the outer can 4 is sealed and thus the inside of the battery is hermetically sealed.

In addition, the cover plate 9 is provided with an injection opening (denoted by reference numeral 14 in the drawings). The nonaqueous electrolyte is injected into the battery through the injection opening during the assembly of the battery, and then the injection opening is sealed. Further, the cover plate 9 is provided with a safety valve 15 for preventing explosion.

In the battery of Example 1, the outer can 4 and the cover plate 9 function as a positive electrode terminal by welding the positive electrode current collector plate 7 directly to the cover plate 9, and the terminal 11 functions as a negative electrode terminal by welding the negative electrode current collector plate 8 to a lead plate 13 and conducting the negative electrode current collector plate 8 and the terminal 11 through the lead plate 13. However, depending on the material, etc., of the outer can 4, the positive and the negative may be reversed.

FIG. 2 is a perspective view schematically showing the external appearance of the battery shown in FIG. 1. FIG. 2 is illustrated to indicate that the battery is a rectangular battery, so that the battery in FIG. 2 is shown schematically and only specific components of the battery are illustrated. Similarly, in FIG. 1, the inner circumferential part of the electrode group is not hatched.

### Example 2

A 20-μm thick separator was produced in the same manner as in Example 1 except that dimethyl sulfoxide (SP value: 12.9) was used as the solvent (b). And except for using this separator, a nonaqueous electrolyte secondary battery was produced in the same manner as in Example 1. V_{sb}Vₛₐ as the volume ratio between the solvents (a) and (b) that were used in the separator forming slurry was 0.125.

### Example 3

The same separator forming slurry as that prepared in Example 1 was applied to both sides of the same negative electrode as that produced in Example 1 with a dip coater, and all were irradiated with ultraviolet rays having a wavelength of 365 nm at an illuminance of 1081 mW/cm² for 10 seconds, followed by drying, to give a negative electrode including a 20-μm thick separator on both sides.

Then, a nonaqueous electrolyte secondary battery was produced in the same manner as in Example 1 except for the use of a flat wound electrode group produced by placing this negative electrode and the same positive electrode as that produced in Example 1 on each other through one of the separators of the negative electrode.

### Example 4

The same separator forming slurry as that prepared in Example 1 was applied to both sides of the same positive electrode as that produced in Example 1 with a dip coater, and all were irradiated with ultraviolet rays having a wavelength of 365 nm at an illuminance of 1081 mW/cm² for 10 seconds, followed by drying, to give a positive electrode including a 21-μm thick separator on both sides.

Then, a nonaqueous electrolyte secondary battery was produced in the same manner as in Example 1 except for the use of a flat wound electrode group produced by placing this positive electrode and the same negative electrode as that produced in Example 1 on each other through one of the separators of the positive electrode.

### Comparative Example 1

A 21-μm thick separator was produced in the same manner as in Example 1 except that the amount of methyl ethyl ketone serving as the solvent (a) was changed to 66.6 parts by mass and no solvent (b) was used. And except for using this separator, a nonaqueous electrolyte secondary battery was produced in the same manner as in Example 1.

### Comparative Example 2

A 21-μm thick separator was produced in the same manner as in Example 1 except that the amount of methyl ethyl ketone serving as the solvent (a) was changed to 63.6 parts by mass and the amount of ethylene glycol serving as the solvent (b) was changed to 3 parts by mass. And except for using this separator, a nonaqueous electrolyte secondary battery was produced in the same manner as in Example 1. V_{sb}/Vₛₐ as the volume ratio between the solvents (a) and (b) that were used in the separator forming slurry was 0.034.

### Comparative Example 3

A 50-μm thick separator was produced in the same manner as in Example 1 except that the amount of methyl ethyl ketone serving as the solvent (a) was changed to 51.6 parts by mass and the amount of ethylene glycol serving as the solvent (b) was changed to 15 parts by mass. And except for using this separator, a nonaqueous electrolyte secondary battery was produced in the same manner as in Example 1. V_{sb}/Vₛₐ as the volume ratio between the solvents (a) and (b) that were used in the separator forming slurry was 4.76.

### Comparative Example 4

A nonaqueous electrolyte secondary battery was produced in the same manner as in Example 1 except that a commercially available polyolefin microporous film (thickness: 20 μm) was used as a separator.

With regard to each of the separators used in the nonaqueous electrolyte secondary batteries of Examples and Comparative Examples, the uniformity, Gurley value and porosity were determined. The uniformity was evaluated by visual inspection, and the Gurley value and the porosity were determined by the methods described above (for the separators of Examples 3 and 4 that were formed on the negative electrode surface and the positive electrode surface, respectively, their Gurley values were not determined).

Further, the nonaqueous electrolyte secondary batteries of Examples and Comparative Examples were subjected to the following charge-discharge test.

<Charge-Discharge Test>

The batteries of Examples and Comparative Examples were charged at a constant current of 0.2 C until the battery voltage reached 4.2 V, and then were charged at a constant voltage of 4.2 V. The total charging time was 8 hours. The batteries whose current did not decline to 0.02 C or less at the end of the constant voltage charging were determined to have caused micro-short circuiting. The point for the batteries whose voltage did not reach 4.2 V as a result of micro-short circuiting was 1.0, the point for the batteries whose current value did not attenuate even though whose voltage reached 4.2 V was 0.5, and the point for the batteries whose current value attenuated and whose voltage also reached 4.2 V was 0. The short-circuiting rate was determined by dividing the total sum of the points by the numbers of the batteries measured (five batteries each for Examples and Comparative Examples).

Further, each of the batteries (the batteries that did not cause micro-short circuiting) after the above-described constant voltage charging was measured for the internal resistance, and then were discharged at a constant current of 0.2 C until the battery voltage became 2.5 V.

Next, each of the discharged batteries was charged under the same conditions as described above, then was discharged at a constant current of 0.2 C until the battery voltage became 2.5 V, and the discharge capacity (0.2 C discharge capacity) was determined. Furthermore, each of the batteries whose 0.2 C discharge capacity had been measured was charged under the same conditions as described above, then discharged at a constant current of 1 C until the battery voltage became 2.5 V, and the discharge capacity (1 C discharge capacity) was determined. Then, the value obtained by dividing the 1 C discharge capacity by the 0.2 C discharge capacity was expressed in percentage, and this was determined as the capacity retention rate. The higher the capacity retention rate, the better the load characteristics of the battery

<Temperature Elevation Test>

In a testing laboratory controlled to have a temperature of 20° C., the batteries of Examples and Comparative Examples were charged at a current of 0.5 C until each battery voltage reached 4.2 V. Each of the charged batteries was placed in a thermostatic oven, the temperature inside the oven was elevated at a rate of 5° C./min until the temperature reached 160° C., and the temperature was held at 160° C. for 1 hour. And from the beginning of the test to the end of the constant value operation at 160° C. for 1 hour, the highest reached temperature of each of the batteries was measured with a thermocouple connected onto the battery surface. Thereafter, each of the batteries was taken out from the thermostatic oven, and cooled at ambient temperature for 10 hours, followed by a measurement of each battery voltage. For each of Examples and Comparative Examples, three batteries were used in the temperature elevation test to determine their average highest temperature and average battery voltage, and those obtained were taken as the average highest temperature and the average battery voltage of each of the batteries of Examples and Comparative Examples.

Table 1 shows the configuration of the solvents of each separator forming slurry used in the formation of the separator that was used in the nonaqueous electrolyte secondary battery of each of Examples and Comparative Examples, Table 2 shows the structure and characteristics of each separator, and Table 3 shows the evaluation results of the nonaqueous electrolyte secondary batteries of Examples and Comparative Examples.

TABLE 1

| | Solvents of separator forming compositions | | |
|---|---|---|---|
| | SP value | | |
| | Solvent (a) | Solvent (b) | V_{sb}/Vₛₐ |
| Ex. 1 | 9.3 | 14.1 | 0.127 |
| Ex. 2 | 9.3 | 12.9 | 0.125 |
| Ex. 3 | 9.3 | 14.1 | 0.127 |
| Ex. 4 | 9.3 | 14.1 | 0.127 |
| Comp. Ex. 1 | 9.3 | — | — |
| Comp. Ex. 2 | 9.3 | 14.1 | 0.034 |
| Comp. Ex. 3 | 9.3 | 14.1 | 4.76 |
| Comp. Ex. 4 | — | — | — |

TABLE 2

| | Configuration and characteristics of separators | | | | | |
|---|---|---|---|---|---|---|
| | | Thickness | | Porosity | Gurley value | |
| | Form | (μm) | V_{A}/V_{B} | (%) | (sec/100 mL) | Uniformity |
| Ex. 1 | Independent film | 20 | 1.22 | 47 | 47 | Uniform |
| Ex. 2 | Independent film | 20 | 1.22 | 31 | 200 | Uniform |
| Ex. 3 | Integral with | 20 | 1.22 | 42 | — | Uniform |
| | negative electrode | | | | | |
| Ex. 4 | Integral with | 21 | 1.22 | 45 | — | Uniform |
| | positive electrode | | | | | |
| Comp. Ex. 1 | Independent film | 21 | 1.22 | 26 | ∞ | Uniform |
| Comp. Ex. 2 | Independent film | 21 | 1.22 | 30 | ∞ | Uniform |
| Comp. Ex. 3 | Independent film | 50 | 1.22 | 30 | ∞ | Non-uniform |
| Comp. Ex. 4 | Independent film | 20 | — | 50 | 90 | Uniform |

TABLE 3

| | | | Load | Temperature elevation test | |
|---|---|---|---|---|---|
| | | | character- | | Highest |
| | | | istics | | reached |
| | Internal | Short- | Capacity | Post-test | temperature |
| | resistance | circuiting | retention | voltage | during test |
| | (mΩ) | rate | rate (%) | (V) | (° C.) |
| Ex. 1 | 0.65 | 0 | 88 | 3.8 | 151 |
| Ex. 2 | 1.10 | 0 | 85 | 3.7 | 151 |
| Ex. 3 | 0.60 | 0 | 89 | 3.8 | 153 |
| Ex. 4 | 0.60 | 0 | 89 | 3.8 | 152 |
| Comp. | 4.50 | Unable | — | — | — |
| Ex. 1 | | to be | | | |
| | | charged/ | | | |
| | | discharged | | | |
| Comp. | 3.50 | Unable | — | — | — |
| Ex. 2 | | to be | | | |
| | | charged/ | | | |
| | | discharged | | | |
| Comp. | 4.50 | 100 | — | — | — |
| Ex. 3 | | | | | |
| Comp. | 0.50 | 0 | 89 | 0.05 | 160 |
| Ex. 4 | | | | | |

As shown in Tables 1 to 3, the separators used in the nonaqueous electrolyte secondary batteries of Examples 1 to 4, each of which was formed using the separator forming slurry that contained the solvent (a) capable of dissolving the resin raw materials and the solvent (b) capable of causing the resin raw materials to agglomerate by solvent shock at an appropriate volume ratio, were high in uniformity and had small Gurley values and thus favorable air permeability. Thus, it is considered that fine and uniform pores were formed in the separators in a favorable manner. Therefore, each of the nonaqueous electrolyte secondary batteries of Examples 1 to 4 using such separators had a low internal resistance, a short-circuiting rate of 0 and a high capacity retention rate during the load characteristic evaluation, presenting a high level of reliability. Moreover, unlike the battery of Comparative Example 4 using an ordinary polyolefin microporous film separator, no decline in voltage was seen in the nonaqueous electrolyte secondary batteries of Examples 1 to 4 after the temperature elevation test. Also, their highest reached temperatures were lower than that of the battery of Comparative Example 4, presenting a high level of safety.

In contrast, the separator of the nonaqueous electrolyte secondary battery of Comparative Example 1, which was formed using the separator forming slurry that contained no solvent (b), and the separators of the nonaqueous electrolyte secondary batteries of Comparative Examples 2 and 3, each of which was formed using the separator forming slurry that contained the solvents (a) and (b) at an inadequate volume ratio, each had small porosity and a high Gurley value. It is considered that the formation of pores did not advance in these separators in a favorable manner. The batteries of Comparative Examples 1 to 3 using these separators each had a high internal resistance. The reason for this might be that the separators had poor lithium ion permeability. Further, the batteries of Comparative Examples 1 and 2 were unable to be charged/discharged and the battery of Comparative Example 3 had a very high short-circuiting rate, presenting poor reliability. The reason for these might be that a current passed through a small number of pores in the separators intensively, thereby facilitating the formation of lithium dendrites. Therefore, the load characteristics of the batteries of Comparative Examples 1 to 3 could not be evaluated and the batteries could not be subjected to the temperature elevation test.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

### INDUSTRIAL APPLICABILITY

The electrochemical device of the present invention can be used in the same applications as those of conventionally known electrochemical devices.

### DESCRIPTION OF REFERENCE NUMERALS

1 positive electrode
2 negative electrode
3 separator

1. A method for producing a separator for an electrochemical device, the method comprising:
preparing a separator forming composition, wherein the separator forming composition contains a resin raw material comprising at least one of a monomer and an oligomer that are polymerizable by energy ray irradiation, a solvent (a) capable of dissolving the resin raw material, and a solvent (b) capable of causing the resin raw material to agglomerate by solvent shock, and V_{sb}/Vₛₐ as a ratio between a volume Vₛₐ of the solvent (a) and a volume V_{sb} of the solvent (b) is 0.04 to 0.2;
applying the separator forming composition to a substrate;
irradiating with an energy ray a coating of the separator forming composition applied to the substrate to form a resin (A) having a crosslinked structure; and
drying the energy ray-irradiated coating of the separator forming composition to form pores.

2. The method according to claim 1, wherein the solvent (a) has a solubility parameter of 8.9 or more and 9.9 or less, and the solvent (b) has a solubility parameter of more than 10 and 15 or less.

3. The method according to claim 1, wherein the separator forming composition further contains inorganic fine particles (B).

4. The method according to claim 3, wherein the inorganic fine particles (B) are of alumina, titania, silica or boehmite.

5. The method according to claim 1, wherein the separator forming composition further contains a fibrous material (C).

6. The method according to claim 1, wherein the separator forming composition further contains at least one of a resin (D) having a melting point of 80 to 140° C. and a resin (E) that swells by absorbing a liquid nonaqueous electrolyte when heated and whose degree of swelling increases with an increase in temperature.

7. A separator for an electrochemical device produced by the method according to claim 1.

8. (canceled)

9. An electrochemical device comprising a positive electrode, a negative electrode, a separator and a nonaqueous electrolyte,
wherein the separator is the separator according to claim 7.

10. The electrochemical device according to claim 9, wherein the separator is integral with at least one of the positive electrode and the negative electrode.

11. A separator for an electrochemical device produced by the method according to claim 4, wherein V_{A}/V_{B} as a ratio between a volume V_{A} of the resin (A) and a volume V_{B} of the inorganic fine particles (B) is 0.6 to 9.

12. A separator for an electrochemical device produced by the method according to claim 5, wherein V_{A}/V_{B} as a ratio between a volume V_{A} of the resin (A) and a volume V_{B} of the inorganic fine particles (B) is 0.6 to 9.
